(19) United States
(12) Patent Application Publication
(10) Pub. No.: US 2017/0309181 A1
(43) Pub. Date: Oct. 26, 2017

(54) APPARATUS FOR RECOGNIZING FOLLOWING VEHICLE AND METHOD THEREOF

(71) Applicants: HYUNDAI MOTOR COMPANY, Seoul (KR); AJOU UNIVERSITY INDUSTRY-ACADEMIC COOPERATION FOUNDATION, Suwon-si (KR)

(72) Inventors: Hoon LEE, Gunpo-si (KR); Seongkeun PARK, Seoul (KR); Hyun Ju KIM, Yongin-si (KR); Min Kyun YOO, Seoul (KR); Ju Yun RO, Seoul (KR); Young Won KIM, Suwon-si (KR); Bong Sob SONG, Suwon-si (KR); Gi Hyun HAN, Suwon-si (KR); Tae Ryun KIM, Suwon-si (KR); Jin Hyeon PARK, Suwon-si (KR)

(21) Appl. No.: 15/497,588

(22) Filed: Apr. 26, 2017

(30) Foreign Application Priority Data
Apr. 26, 2016 (KR) 10-2016-0050872
Apr. 26, 2017 (KR) 10-2017-0053333

(51) Int. Cl. G08G 1/16; B60Q 1/34; G06K 9/00; G01S 13/93

(52) U.S. Cl. CPC G08G 1/167; G06K 9/00805; G01S 13/931; B60Q 1/34; B60Q 2400/50; G01S 2013/9378

(57) ABSTRACT

An apparatus for recognizing a following vehicle includes a rear radar for detecting an object located in the rear of a subject vehicle, a guardrail area detector for detecting a guardrail area of a road using a road image of front of the subject vehicle and an image of a stationary object among objects detected by the rear radar, and a following vehicle recognizing unit for recognizing, as a following vehicle, a vehicle located on a road in the same traveling direction as that of the subject vehicle among objects detected by the rear radar, wherein the following vehicle is not included in the guardrail area detected by the guardrail area detector.

### CROSS-REFERENCE TO RELATED APPLICATIONS

This application claims the benefit of priority to Korean Patent Application 10-2016-0050872 filed on Apr. 26, 2016, and Korean Patent Application No. 10-2017-0053333 filed on Apr. 26, 2017, in the Korean Intellectual Property Office (KIPO), the entire contents of which are hereby incorporated by reference.

### TECHNICAL FIELD

The present disclosure relates to an apparatus for recognizing a following vehicle and a method thereof, and more specifically to a technique for recognizing a following vehicle with high accuracy based on a front vision sensor and a rear radar.

### BACKGROUND

Research is being conducted on technologies that can reduce traffic accidents by integrating advanced IT technologies such as sensors and communications into automobiles. Such research produces societal and economic benefits.

As a part of this research, a lane departure warning system and a blind spot monitoring device are being applied to automobiles. The lane departure warning system prevents accidents caused by drowsy driving or inadvertent departures from a lane during driving. The blind spot monitoring device indicates the presence of other vehicles or obstacles located in a blind spot that is not covered by a front view range of the driver and a rear view range using a rear view mirror.

In the early 1990s, blind spot monitoring systems that provide information about other vehicles located in a blind spot or approaching towards the subject vehicle using an ultrasonic sensor were employed on automobiles. Additional detection technologies, including image processing and radar, have also been used. In Korea, there has been continuous research and development on driving support devices that support safe driving prior to an accident, and preventive safety devices for collision mitigation and accident avoidance.

In general, the performance of the LCA (Lane Change Alert) system and the BSD (Blind Spot Detection) system depends on how accurately one perceives a subsequent vehicle. That is, since the objects that can be detected by the rear radar on the road include other vehicles, the landscape, the guardrail and other street features, it is necessary to accurately recognize the other vehicle to improve the performance of each system.

Conventional vehicle recognition technology judges whether a detected object is a stationary object or a moving object by consideration of the relationship between the speed of the vehicle and the speed of the object measured through various sensors. As a result, conventional vehicle recognition technology may only achieve low accuracy because it recognizes whether the other vehicle is based on the relative speed with the object.

In addition, conventional vehicle recognition technology unnecessarily recognizes not only a vehicle following a subject vehicle in a lane in the same traveling direction but also another vehicle traveling in a reverse lane, thereby lowering performance of the system.

### SUMMARY

Accordingly, exemplary implementations of the present disclosure are provided to substantially obviate one or more problems due to limitations and disadvantages of the related art. Exemplary implementations of the present disclosure provide an apparatus for recognizing a following vehicle.

In order to achieve the objectives of the present disclosure, an apparatus for recognizing a following vehicle may comprise a rear radar for detecting an object located in the rear of a subject vehicle; a guardrail area detector for detecting a guardrail area of a road using a road image of front of the subject vehicle and an image of a stationary object among objects detected by the rear radar; and a following vehicle recognizing unit for recognizing, as a following vehicle, a vehicle located on a road in the same traveling direction as that of the subject vehicle among objects detected by the rear radar, wherein the following vehicle is not included in the guardrail area detected by the guardrail area detector.

Particularly, the guardrail area detector may be configured to generate a curve passing through the center of the subject vehicle by applying a road model to the curvature of the road calculated based on the road image of front of the subject vehicle, project the curve onto each stationary object detected by the rear radar, and detect a group of projection curves positioned within a predetermined range as a guardrail area.

Further, the guardrail area detector may comprise a curvature calculator for calculating a curvature of a road based on a road image of front of the subject vehicle; a curve generator for generating a curve passing through the center of the subject vehicle by applying a road model to the curvature of the road calculated by the curvature calculator, a projector for projecting the curve generated by the curve generator onto a still object image of the object detected by the rearward radar; and a determiner for grouping a plurality of curves located within a critical distance on the basis of a curve located closest to the spur of the curved line projected by the projector as a guardrail.

Furthermore, the guardrail area detector may further comprise a road model storage storing a plurality road models.

Moreover, the curve generator cumulatively may store generated curves to generate a curve extending from the front to the rear of the subject vehicle.

In addition, the determiner may recognize a moving object located at the opposite side of the guardrail with respect to the position of the subject vehicle as the subject vehicle in the opposite lane.

Furthermore, the apparatus for recognizing a following vehicle may further comprise a vision sensor disposed towards the front of the subject vehicle to obtain a road image of front of the subject vehicle.

Additionally, a method for recognizing a following vehicle may comprise detecting an object located in the rear of a subject vehicle; detecting a guardrail area of a road using a road image of front of the subject vehicle and an image of a stationary object among objects detected by the rear radar; and recognizing, as a following vehicle, a vehicle located on a road in the same traveling direction as that of the subject vehicle among objects detected by the rear radar, wherein the following vehicle is not included in the guardrail area detected by the guardrail area detector.

Particularly, the detecting the guardrail area may comprise calculating a curvature of a road based on a road image of front of the subject vehicle; generating a curve passing through the center of the subject vehicle by applying a road model to the curvature of the road; projecting the curve generated by the curve generator onto a still object image of the object detected by the rearward radar; and grouping a plurality of curves located within a critical distance on the basis of a curve located closest to the spur of the curved line projected by the projector as a guardrail.

Moreover, the generating a curve passing through the center of the subject vehicle may comprise cumulatively storing generated curves to generate a curve extending from the front to the rear of the subject vehicle.

Further, the recognizing, as a following vehicle, a vehicle located on a road in the same traveling direction as that of the subject vehicle among objects detected by the rear radar may comprise recognizing a moving object located at the opposite side of the guardrail with respect to the position of the subject vehicle as the subject vehicle in the opposite lane.

In addition, the method for recognizing a following vehicle may further comprise obtaining a road image of front of the subject vehicle through a vision sensor disposed towards the front of the subject vehicle.

Additionally an apparatus for recognizing a following vehicle may comprise a vision sensor disposed towards the front of a subject vehicle to obtain a road image of front of the subject vehicle; a rear radar for detecting an object located in the rear of the subject vehicle; and a processor configured to detect a guardrail area of a road using a road image of front of the subject vehicle and an image of a stationary object among objects detected by the rear radar and recognize, as a following vehicle, a vehicle located on a road in the same traveling direction as that of the subject vehicle among objects detected by the rear radar, wherein the following vehicle is not included in the guardrail area detected by the guardrail area detector.

According to the present disclosure as described above, the position of the detected object is recognized by using the guardrail region and the rear radar generated based on the front vision sensor and the road model, and it is judged whether the object is the guardrail or the succeeding vehicle, so that the following vehicle can be recognized with high accuracy

### BRIEF DESCRIPTION OF THE DRAWINGS

Exemplary implementations of the present disclosure will become more apparent by describing in detail exemplary implementations of the present disclosure with reference to the accompanying drawings, in which:

FIG. 1 is a diagram illustrating a blind spot monitoring system to which the present disclosure may be applied;

FIG. 2 is a schematic block diagram illustrating a blind spot monitoring apparatus to which the present disclosure may be applied;

FIG. 3 is a schematic block diagram illustrating an apparatus for recognizing a following vehicle according to an exemplary implementation of the present disclosure;

FIGS. 4a to 4c are diagrams illustrating a guardrail area detecting process according to exemplary implementations of the present disclosure;

FIG. 5 is a flowchart illustrating a method for recognizing a following vehicle according to an exemplary implementation of the present disclosure;

FIG. 6 is a flowchart illustrating a method for recognizing a following vehicle according to an exemplary implementation of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

In the present disclosure, the rear vehicle may mean any type of vehicle in the rear of the vehicle, and the following vehicle may mean a vehicle following the subject vehicle in a lane in the same traveling direction.

Although exemplary implementations are described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present disclosure may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

Since the present disclosure may be variously modified and have several exemplary implementations, specific exemplary implementations will be shown in the accompanying drawings and be described in detail in the detailed description. It should be understood, however, that it is not intended to limit the present disclosure to the specific implementations but, on the contrary, the present disclosure is to cover all modifications and alternatives falling within the spirit and scope of the present disclosure.

Relational terms such as first, second and the like may be used for describing various elements, but the elements should not be limited by the terms. These terms are only used to distinguish one element from another. For example, a first component may be named a second component without being departed from the scope of the present disclosure and the second component may also be similarly named the first component. The term ‘and/or’ means any one or a combination of a plurality of related and described items.

When it is mentioned that a certain component is “coupled with” or “connected with” another component, it should be understood that the certain component is directly “coupled with” or “connected with” to the other component or a further component may be located therebetween. In contrast, when it is mentioned that a certain component is “directly coupled with” or “directly connected with” another component, it will be understood that a further component is not located therebetween.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not to be construed as formal meanings.

Hereinafter, exemplary implementations of the present disclosure will be described in detail with reference to the accompanying drawings. In describing the disclosure, to facilitate the entire understanding of the disclosure, like numbers refer to like elements throughout the description of the figures and repetitive descriptions thereof will be omitted.

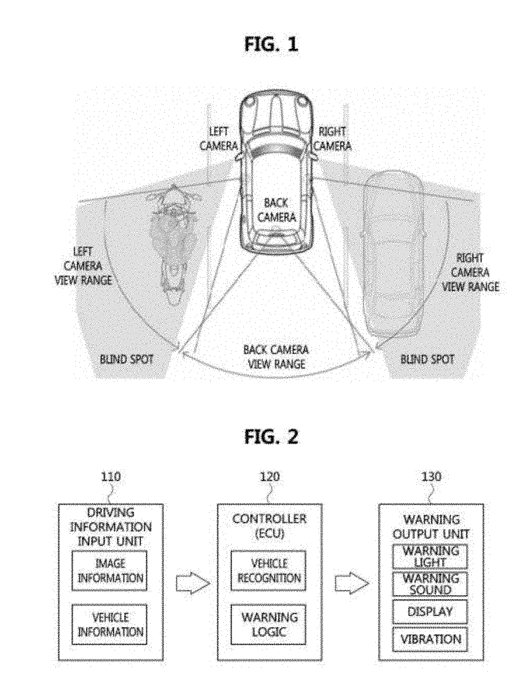

FIG. 1 is a diagram illustrating a blind spot monitoring system to which the present disclosure may be applied.

As shown in FIG. 1, there exists a blind spot around the vehicle in which the driver's view is not provided even through the overhead mirror and the side mirror.

A blind spot detection (BSD) system is a system that provides information to the driver about any other vehicle approaching the subject vehicle or located in a blind spot. That is, the blind spot detection system is a safety system to prevent accidents when the risk of an accident is detected due to a vehicle changing or approaching a lane without recognizing a vehicle in a blind spot.

The blind spot monitoring system generally includes a sensor part for detecting a nearby vehicle/automobile and a device for displaying a warning notice. The blind spot monitoring system is a safety assisting system used instead of reducing the size of a conventional rear view mirror or replacing an indoor/outdoor rear view mirror.

The left side camera, the right side camera, and the rear side camera, as examples or components of the blind spot monitoring system, are shown in FIG. 1. It is shown that many parts of the blind spot can be eliminated by these cameras.

The blind spot monitoring device can be classified according to the type of surveillance sensor and the warning display method. Surveillance sensor type blind spot monitoring devices can include a radar, an ultrasonic and/or a camera. The alarm display method includes a method of alarming by sound, a method of visually displaying on a rearview mirror, and a method of displaying by tactile sensation through a seat vibration. The visual method may have a type of displaying a warning on the glass surface of the outdoor rearview mirror, a type of displaying a warning on the outdoor rearview mirror frame, and a type of displaying a warning on the indoor frame (A-pillar).

FIG. 2 is a schematic block diagram illustrating a blind spot monitoring apparatus to which the present disclosure may be applied.

Referring to FIG. 2, the blind spot monitoring apparatus may comprise a driving information input unit 110, a controller 120 and a warning output unit 130.

The driving information input unit 110 may include various types of monitoring sensors such as a radar device, an ultrasonic wave sensor and a camera. The driving information input unit 110 provides the controller 120 with vehicle information such as image information, traveling speed, and turn signals collected from various monitoring sensors.

The controller 120, including the vehicle recognition function and warning logic, determines the presence of a vehicle through relevant images and vehicle information, determines the surrounding situation, and decides whether to warn the user or not and what kind of warning to provide. The controller 120 may be an Engine Control Unit (ECU) or a Vehicle Control Unit (VCU) of the vehicle, but is not limited thereto.

The ECU (Engine Control Unit) functions to increase engine efficiency through optimum combustion based on the information collected from various sensors related to the engine. The ECU controls the amount of fuel injected, the timing of ignition, variable valve timing control and the like. The ECU according to the present disclosure may control all parts of the vehicle such as the driving system, the braking system, and the steering system as well as the other functions.

According to an exemplary implementation of the present disclosure, the controller 120 may be configured to detect a guardrail area of a road using a road image of a front of the subject vehicle and an image of a stationary object among objects detected by the rear radar and recognize, as a following vehicle, a vehicle located on a road in the same traveling direction as that of the subject vehicle among objects detected by the rear radar, wherein the following vehicle is not included in the guardrail area detected by the guardrail area detector.

When it is determined by the controller 120 to provide a warning to the user, the warning output unit 130 outputs a warning through various forms of display, vibration, etc., such as a warning light, a warning sound, a text, a figure or a drawing.

Regarding the operating conditions of the blind spot monitoring system, for example, a vehicle equipped with a blind spot monitoring system that is running at a constant speed monitors a blind spot and warns the driver with a first warning by lighting a warning light when a car enters into a blind spot. When the driver activates the turn signal and attempts to change the car traveling lane despite the first warning, the system may operate in such a way as to inform the driver of the risk of the collision by providing a secondary warning such as flashing warning light, or warning sound.

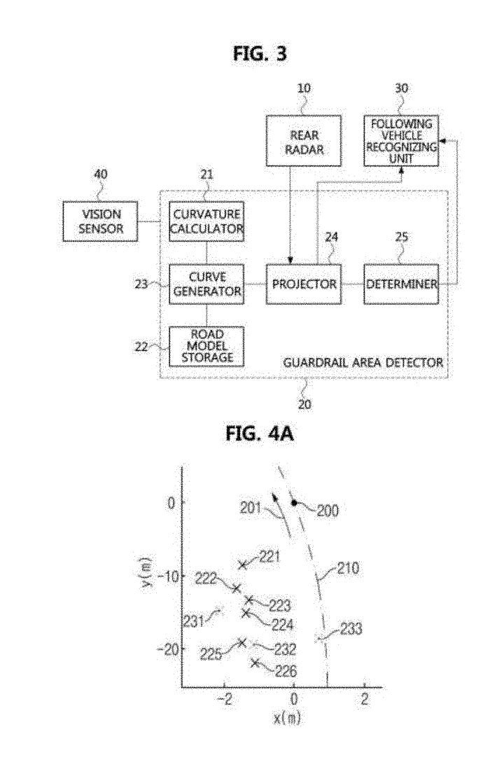

FIG. 3 is a schematic block diagram of an apparatus for recognizing a following vehicle. Referring to FIG. 3, the apparatus for recognizing a following vehicle may comprise a vision sensor 40, a rear radar 10, a guardrail area detector 20 and a following vehicle recognizing unit 30.

First, the rear radar 10 may be mounted on the back of the vehicle to detect a stationary object and a moving object located behind or in the rear of the vehicle. A radar is an acronym of radio detection and ranging and radiates an electromagnetic wave of microwave (microwave, 10 cm˜100 cm wavelength) to an object, receives electromagnetic waves reflected from the object, and detects a distance, a direction and an altitude to the object.

For example, the rear radar 10 includes a transmitter for generating radio waves, an antenna (scanner) for radiating radio waves, a receiver for receiving reflected radio waves, and an indicator for displaying an image on a cathode ray tube. Since the radio wave from the transmitter is usually a microwave (frequency is over 300 MHz), it may be hard to know when the returned radio wave will be emitted when it is continuously radiated. Therefore, the transmitter radiates the radio wave only for a short period of time (about 6-10 seconds) and it radiates the microwave again after the radio wave returns, which is called an intermittent radiation. The number of radiations per second is approximately 1000 times. Since the propagation speed of the microwave is 300,000 kilometers per second, the distance to the target can be obtained by measuring the time taken until the reflected wave is received.

The vision sensor 40 may be mounted on various positions of the vehicle to acquire an image. According to the implementation of the present disclosure, the vision sensor 40 is located in the direction in which the vehicle travels, that is, towards the front of the vehicle. The vision sensor may include, for example, an image sensor, a camera, and the like.

The guardrail area detector 20 may generate a curve passing through the center of the vehicle by applying a road model to the curvature of the road calculated based on the road image in front of the vehicle, project the curve onto each stationary object detected by the rear radar 10, and detect a group of projection curves positioned within a predetermined range as a guardrail area.

The following vehicle recognizing unit 30 may recognize a vehicle positioned in a lane in the same traveling direction as that of the vehicle as a following vehicle, the vehicle not being included in the guardrail area detected by the guardrail area detector 20.

The guardrail area detector 20 may include a curvature calculator 21, a road model storage 22, a curve generator 23, a projector 24 and a determiner 25.

Hereinafter, a possible detailed configuration of the guardrail area detector 20 will be described with reference to FIG. 3.

The curvature calculator 21 calculates the curvature of the road based on the road image of front of the vehicle obtained through a vision sensor (e.g., a camera). Here, the vision sensor may be positioned to face the front of the vehicle.

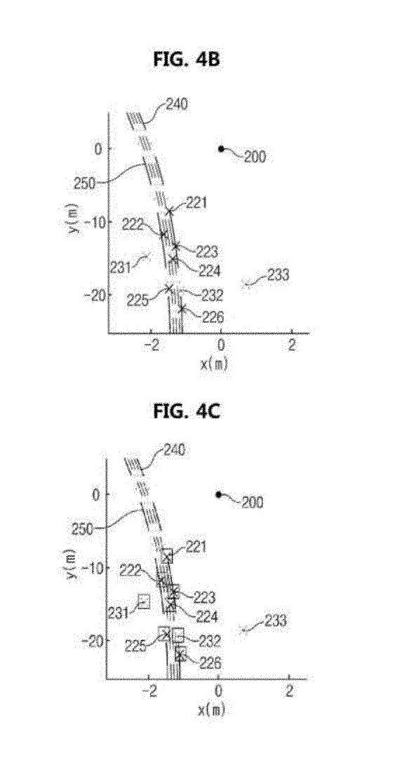

Here, as a technique for calculating the curvature of a road according to the present disclosure, a mathematical algorithm for estimating the geometric characteristics of a road center point using a curved surface topology search method can be used. For example, a least squares approach or a spline approach may be used. In addition, the curvature calculation method according to the present disclosure is not limited to any one method and can be implemented in various ways. The road model storage 22 may store road models for each road. The curve generator 23 may apply a corresponding road model to the curvature of the road calculated by the curvature calculator 21 to generate a curve passing through the center of the vehicle. The generated curve 210 is shown in FIG. 4A.

FIGS. 4A to 4C are diagrams illustrating a guardrail area detecting process according to exemplary implementations of the present disclosure.

In FIG. 4A, ‘200’ represents the center of the vehicle. Here, the curve generator 23 may acquire various information (road information, position information, etc.) in cooperation with a navigation system provided in the vehicle.

The curve generator 23 may accumulate curvatures of the road previously calculated or store curves previously generated since the curve generator 23 uses the curvature of the road calculated based on the road image of front of the vehicle.

In other words, the curve generator 23 may apply the road model to the curvature of the cumulatively stored curvatures of roads to generate curves leading to the front as well as the rear with respect to the center 200 of the vehicle as shown in FIG. 4A. In FIG. 4A, ‘201’ indicates the traveling direction of the vehicle.

The projector 24 projects the curve generated by the curve generator 23 onto the stationary object detected by the rear radar 10. The projected results are shown in FIG. 4B. In FIG. 4B, reference numbers ‘221’, ‘222’, ‘223’, ‘224’, ‘225’ and ‘226’ represent the stationary objects determined by the rear radar 10. Furthermore, reference numbers ‘231’ and ‘233’ denote moving objects determined by the rear radar 10. However, ‘232’ is a stationary object misjudged by the rear radar 10. Here, ‘240’ represents a projected curve that is closest to the vehicle and ‘250’ represents a projected curve that is the farthest from the vehicle.

The projector 24 according to the present disclosure may collect various information (speed, steering angle, etc.) about the vehicle in cooperation with the vehicle network and utilize the collected vehicle information for curve projection.

Here, the vehicle network includes one or more of a Controller Area Network (CAN), a Local Interconnect Network (LIN), a FlexRay, and a Media Oriented System Transport (MOST).

A Controller Area Network (CAN) is a non-host bus based message-based network protocol that is used primarily for communication between controllers. CAN-data buses are mainly used for automobile safety systems, convenience systems, data transmission between ECUs, and control of information communication systems and entertainment systems. CAN operates according to a multi-master principle in which a large number of ECUs in a master/slave system perform a master function.

Local Interconnect Network (LIN) is mainly used for data transmission between ECU and active sensor or active actuator. LIN is much simpler than CAN, uses a slow 12V, single-wire bus, and operates based on a master-slave principle.

FlexRay is an automotive network communication protocol developed by the FlexRay consortium. FlexRay is faster and more reliable than CAN, but it is more expensive. FlexRay bus is mainly used to transfer data between ECUs. FlexRay buses are used in systems that require a high level of data transmission speed and data security, such as brake systems, electronic control suspension systems, and electric steering systems.

MOST (Media Oriented System Transport) is also one of the automotive networking technologies, and is a fiber-based network protocol targeting high performance multimedia networks. It will support from 25 Mbps to 150 Mbps in the future, and the interface standard was created by the MOST Cooperation in Germany.

The determiner 25 may group the curves 250 located within a predetermined distance with reference to the curved line 240 which is located closest to the vehicle among curved lines projected by the projector 24 and judge the group of the curves as guardrails.

That is, as shown in FIG. 4C, ‘221’, ‘222’, ‘223’, ‘224’, ‘225’, ‘226’, and ‘232’ are determined as guardrails. Here, ‘232’ indicates an object positioned between the stationary objects ‘221’ and ‘225’, and the object 232 was misjudged by the rear radar 10 as a moving object.

Further, the determiner 25 may recognize a moving object 231 located on the opposite side of the guardrail with respect to the position of the vehicle, as a vehicle in a reverse lane, and filters the moving object 231 out. This is because vehicles located in the reverse lane may be meaningless data in a Lane Change Alert (LCA) system and BSD (Blind Spot Detection) system.

However, in FIG. 3, the guardrail area detector 20 and the following vehicle recognizing unit 30 are represented as separate blocks. However, the functions of the guardrail area detecting unit 20 and the following vehicle recognizing unit 30 may be incorporated into one processor. The guardrail area detector 20 and the following vehicle recognizing unit 30 may also be integrated into the ECU or VCU 120 as illustrated in FIG. 2.

Accordingly, the apparatus for recognizing a following vehicle according to an implementation of the present disclosure comprises a vision sensor disposed towards the front of the vehicle to obtain a road image of front of the subject vehicle; a rear radar for detecting an object located in the rear of the subject vehicle; and a processor configured to detect a guardrail area of a road using a road image of front of the subject vehicle and an image of a stationary object among objects detected by the rear radar and recognize, as a following vehicle, a vehicle located on a road in the same traveling direction as that of the subject vehicle among objects detected by the rear radar, wherein the following vehicle is not included in the guardrail area detected by the guardrail area detector.

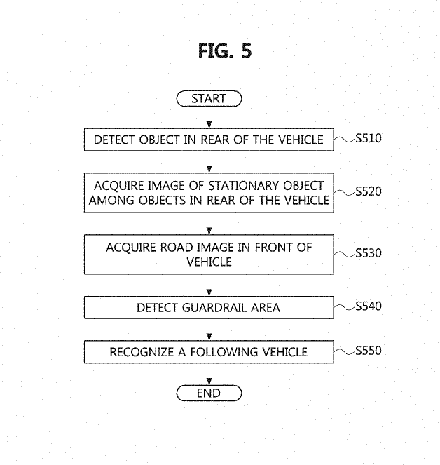

FIG. 5 is a flowchart illustrating a method for recognizing a following vehicle according to an exemplary implementation of the present disclosure.

The following vehicle recognition method shown in FIG. 5 may be performed mainly by the control unit (ECU) or the vehicle control unit shown in FIG. 2, the guardrail area detector and the following vehicle recognition unit shown in FIG. 3, or a processor, but is not limited thereto.

The following vehicle recognition method according to the present disclosure may be applied to a Lane Change Alert system, a Blind Spot Detection system, or Partially Automated Lane Change Systems. The accuracy of detecting following vehicles that may threaten the progress of the vehicle may be an important factor in the performance of these systems.

Partially Automated Lane Change System (PALS) is a system that supports the driver to make lane changes on the road. It may require information about the position of the lane, surrounding lanes and surrounding obstacles.

According to the following vehicle recognizing method, the rear radar 10 may detect an object located behind the vehicle (S510) and acquire one or more image of stationary objects among objects detected by the rear radar (S520). In addition, a road image of a front of the vehicle is obtained through a vision sensor installed toward the front of the vehicle (S530).

Here, although step S530 is shown as being performed after steps S510 and S520 for convenience of illustration, S530 may be performed simultaneously with S510 and S520, or may be performed before S510 and S520.

Thereafter, the guardrail area detector 20 may generate a curve passing through the center of the vehicle by applying a road model to the curvature of the road calculated based on the road image of front of the vehicle, project the curve onto each stationary object detected by the rear radar 10, and detect a group of projection curves positioned within a predetermined range as a guardrail area (S540).

Thereafter, the following vehicle recognizing unit 30 may recognize a vehicle positioned in a lane in the same traveling direction as that of the vehicle as a following vehicle, the vehicle not included in the guardrail area detected by the guardrail area detector 20, among the objects detected by the rear radar (S550). The following vehicle can be recognized with high accuracy through these steps described above.

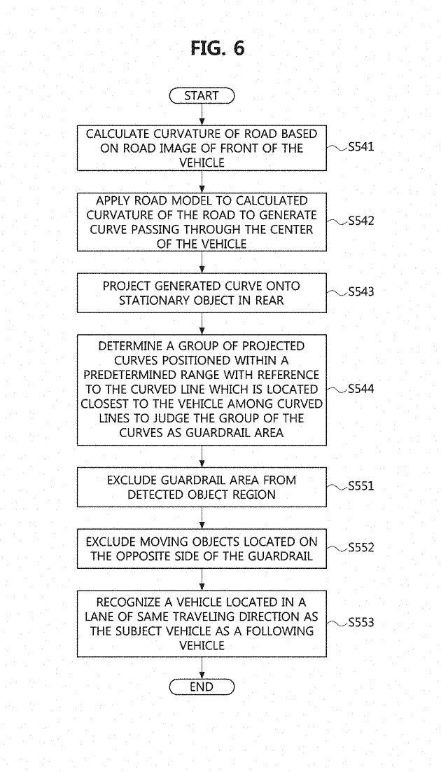

FIG. 6 is a flowchart illustrating a method for recognizing a following vehicle according to an exemplary implementation of the present disclosure.

In FIG. 6, the guardrail area detection process (S540) and the following vehicle recognition process (S550) of the road among the following vehicle recognition methods shown in FIG. 5 are shown in more detail.

The method for recognizing a following vehicle shown in FIG. 6 may be performed mainly by the control unit (ECU) or the vehicle control unit shown in FIG. 2, the guardrail area detector and the following vehicle recognition unit shown in FIG. 3, or a processor, but is not limited thereto.

For example, FIG. 6 illustrates an operation in a state in which the guardrail area detector 20 according to the present disclosure secures the road image in front of the vehicle and the image of the rear stationary object.

First, the guardrail area detector 20 may calculate the curvature of the road based on the road image in front of the vehicle (S541), and apply the road model to the calculated curvature of the road to generate a curve passing through the center of the vehicle (S542). The generated curve is projected onto a stationary object among the objects detected by the rear radar 10 (S543). The guardrail area detector 20 may determine a group of projected curves positioned within a predetermined range with reference to the curved line 240 which is located closest to the vehicle among curved lines to judge the group of the curves as a guardrail area (S544).

Further, the determiner 25 may recognize a moving object 231 located on the opposite side of the guardrail with respect to the position of the vehicle, as a vehicle in a lane with vehicles traveling in an opposite direction, and filter the moving objet 231 out. This is because vehicles located in the reverse lane may be meaningless data in a Lane Change Alert (LCA) system and BSD (Blind Spot Detection) system.

Thereafter, the guardrail area is excluded from the detected object region detected at S510 in FIG. 5 (S551) and any moving objects located at the opposite side of the guardrail are also excluded (S552). In the remaining area excluding the moving object located at the opposite side of the guardrail and the guardrail area, the vehicle located in a lane of the same traveling direction as the vehicle is recognized as a following vehicle (S553).

The following vehicle recognition method of the present disclosure as described above can be written in a computer program that includes instructions for performing the steps of the method. And the code and code segments constituting the program can be easily deduced by a computer programmer in the field. Further, the created program may be stored in a computer-readable recording medium (information storage medium), and is read and executed by a computer to implement the method of the present disclosure. The recording medium includes all types of recording media readable by a computer.

The methods according to exemplary implementations of the present disclosure may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for the present disclosure or can be publicly known and available to those who are skilled in the field of computer software.

Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the operation of the present disclosure, and vice versa.

While the exemplary implementations of the present disclosure and their advantages have been described in detail, it should be understood that various changes, substitutions and alterations may be made herein without departing from the scope of the disclosure.

What is claimed is:

1. An apparatus for recognizing a following vehicle, comprising:
a rear radar for detecting an object located in the rear of a subject vehicle;
a guardrail area detector for detecting a guardrail area of a road using a road image of a front of the subject vehicle and an image of a stationary object among objects detected by the rear radar; and
a following vehicle recognizing unit for recognizing, as a following vehicle, a vehicle located on a road in the same traveling direction as that of the subject vehicle among objects detected by the rear radar, the following vehicle not being included in the guardrail area detected by the guardrail area detector.

2. The apparatus of claim 1, wherein the guardrail area detector generates a curve passing through a center of the subject vehicle by applying a road model to a curvature of the road calculated based on the road image of the front of the subject vehicle, projects the curve onto each stationary object detected by the rear radar, and detects a group of projection curves positioned within a predetermined range as a guardrail area.

3. The apparatus of claim 1, wherein the guardrail area detector comprises:
a curvature calculator for calculating a curvature of a road based on a road image of a front of the subject vehicle; and
a curve generator for generating a curve passing through a center of the subject vehicle by applying a road model to the curvature of the road calculated by the curvature calculator.

4. The apparatus of claim 3, the guardrail area detecting unit further comprising:
a projector for projecting the curve generated by the curve generator onto a still object image of the object detected by the rearward radar; and
a determiner for grouping a plurality of curves located within a critical distance on the basis of a curve located closest to the spur of the curved line projected by the projector as a guardrail.

5. The apparatus of claim 3, wherein the guardrail area detecting unit further comprises a road model storage storing a plurality road models.

6. The apparatus of claim 3, wherein the curve generator cumulatively stores generated curves to generate a curve extending from the front to the rear of the subject vehicle.

7. The apparatus of claim 4, wherein the determiner recognizes a moving object located at an opposite side of the guardrail with respect to the position of the subject vehicle as another vehicle in an opposite lane.

8. The apparatus of claim 1, further comprising:
a vision sensor disposed towards the front of the subject vehicle to obtain a road image of a front of the subject vehicle.

9. A method for recognizing a following vehicle, comprising:
detecting an object located in the rear of a subject vehicle;
detecting a guardrail area of a road using a road image of a front of the subject vehicle and an image of a stationary object among objects detected by the rear radar; and
recognizing, as a following vehicle, a vehicle located on a road in the same traveling direction as that of the subject vehicle among objects detected by the rear radar, the following vehicle not being included in the guardrail area detected by the guardrail area detector.

10. The method of claim 9, wherein the step of detecting the guardrail area further comprises:
calculating a curvature of a road based on a road image of front of the subject vehicle; and
generating a curve passing through a center of the subject vehicle by applying a road model to the curvature of the road.

11. The method of claim 10, wherein the step of detecting the guardrail area further comprises:
projecting the curve generated by the curve generator onto a still object image of the object detected by the rearward radar; and
grouping a plurality of curves located within a critical distance on the basis of a curve located closest to the spur of the curved line projected by the projector as a guardrail.

12. The method of claim 10, wherein the step of generating a curve passing through the center of the subject vehicle comprises:
cumulatively storing generated curves to generate a curve extending from the front to the rear of the subject vehicle.

13. The method of claim 9, wherein the step of recognizing, as a following vehicle, a vehicle located on a road in the same traveling direction as that of the subject vehicle among objects detected by the rear radar further comprises:
recognizing a moving object located at an opposite side of the guardrail with respect to the position of the subject vehicle as another vehicle in the opposite lane.

14. The method of claim 9, further comprising:
obtaining a road image of a front of the subject vehicle through a vision sensor disposed towards the front of the subject vehicle.

15. An apparatus for recognizing a following vehicle, comprising:
a rear radar for detecting an object located in a rear of the subject vehicle;
a vision sensor for obtaining a road image of a front of the subject vehicle; and
a processor for detecting a guardrail area of a road using a road image of the front of the subject vehicle and an image of a stationary object among objects detected by the rear radar and recognize, as a following vehicle, a vehicle located on a road in the same traveling direction as that of the subject vehicle among objects detected by the rear radar, the following vehicle not being included in the guardrail area detected by the guardrail area detector.
